(19) United States
(12) Patent Application Publication
(10) Pub. No.: US 2026/0000263 A1
(43) Pub. Date: Jan. 1, 2026

(54) CLEANING METHOD, CLEANING ROBOT AND COMPUTER-READABLE STORAGE MEDIUM

(71) Applicant: Yunjing Intelligence (Shenzhen) Co., Ltd., Shenzhen (CN)

(72) Inventor: Junbin Zhang, Shenzhen (CN)

(21) Appl. No.: 19/318,733

(22) Filed: Sep. 4, 2025

Related U.S. Application Data
(62) Division of application No. 17/545,842, filed on Dec. 8, 2021, now Pat. No. 12,426,760.

(30) Foreign Application Priority Data
Dec. 10, 2020 (CN) 202011437304.6

(51) Int. Cl. A47L 11/40; A47L 11/24; A47L 11/28; A47L 11/282

(52) U.S. Cl. CPC A47L 11/4061; A47L 11/24; A47L 11/28; A47L 11/282; A47L 11/4011; A47L 11/4066; A47L 2201/04

(57) ABSTRACT

A cleaning method of a cleaning robot includes, when the cleaning robot travels along an obstacle, driving a rear end of the cleaning robot, on which a cleaning member is arranged, to make multiple turning motions towards the obstacle and multiple backswings away from the obstacle, thereby cleaning a blind zone of the cleaning robot relative to the obstacle. In such a way, blind zones are cleaned when cleaning along obstacles.

### CROSS-REFERENCE TO RELATED APPLICATIONS

This patent application is a divisional of U.S. patent application Ser. No. 17/545,842, filed Dec. 8, 2021, which claims the benefit of priority to Chinese application No. 202011437304.6, filed Dec. 10, 2020. All of the aforementioned applications are hereby incorporated by reference in their entireties.

### FIELD OF THE INVENTION

The present invention relates to technical field of cleaning robots, and in particular to a cleaning method, a cleaning robot and a computer readable storage medium.

### BACKGROUND OF THE INVENTION

Referring to FIGS. 1 and 2, a cleaning robot includes a sweeping module 11 arranged at the bottom front end of the cleaning robot and a mopping module 12 arranged at the bottom rear end of the cleaning robot. In the process of using the cleaning robot to perform edge cleaning according to the conventional edge travelling direction, a blind zone is formed between the cleaning member of the mopping module 12 and the obstacle and cannot be cleaned, which will affect the cleaning effect of the cleaning robot.

### SUMMARY OF THE INVENTION

A technical problem to be solved by the present invention is that, when cleaning along an edge of an obstacle, a blind zone is formed between the cleaning member at the rear end of the cleaning robot and the obstacle and cannot be cleaned, which will affect the cleaning effect of the cleaning robot.

In order to solve the above technical problems, a first aspect of the present invention is to provide a cleaning method of a cleaning robot, and the cleaning method includes when the cleaning robot travels along an obstacle, driving a rear end of the cleaning robot on which a cleaning member is arranged to make multiple turning motions towards the obstacle and multiple backswings away from the obstacle, thereby cleaning a blind zone of the cleaning robot relative to the obstacle.

Preferably, the cleaning method further includes controlling a current cleaning zone cleaned in each current turning motion to be partially overlapped with or adjacent with a previous cleaning zone cleaned in a previous turning motion.

Preferably, the cleaning method further includes driving the rear end of the cleaning robot to make the turning motions towards the obstacle if a constraint condition of traveling along the obstacle is satisfied.

Preferably, the constraint condition of traveling along the obstacle comprises: a distance between the cleaning robot and the obstacle detected in real time being equal to a preset distance threshold or falling within a preset distance interval.

Preferably, the cleaning method further includes driving the rear end of the cleaning robot to make the turning motions towards the obstacle when the cleaning robot stops travelling.

Preferably, the cleaning method further includes controlling a current cleaning zone in each current turning motion to be partially overlapped with or adjacent with a previous cleaning zone in a previous backswing.

Preferably, the cleaning method further includes driving the rear end of the cleaning robot to start the turning motions towards the obstacle, along an initial travelling direction of the cleaning robot along the obstacle; and driving the rear end of the cleaning robot to make the backswings back to the initial travelling direction or a previous position.

Preferably, the turning motions and the backswings are made during a continuous travelling of the cleaning robot.

Preferably, the cleaning robot travels in a wave style or a zigzag style.

A second aspect of the present invention is to provide a cleaning method of a cleaning robot, and the cleaning method includes stopping travelling of the cleaning robot along an obstacle and driving a rear end of the cleaning robot on which a cleaning member is arranged to make a turning motion towards the obstacle; driving the rear end of the cleaning robot to make a backswing from a previous turning position; and restarting the travelling of the cleaning robot along the obstacle with a first distance.

Preferably, the cleaning method further includes controlling a current cleaning zone cleaned in each current turning motion to be partially overlapped with or adjacent with a previous cleaning zone cleaned in a previous turning motion.

Preferably, the cleaning method further includes when the cleaning robot turns along the obstacle, adjusting the first distance and the number of turning motions according to a turning radius of the cleaning robot along the obstacle.

Preferably, when the turning radius of the cleaning robot along the obstacle is small, the first distance traveled by the cleaning robot is large, and the number of turning motions is small.

Preferably, when the turning radius of the cleaning robot along the obstacle is small, the first distance traveled by the cleaning robot is small, and the number of turning motions is large.

A third aspect of the present invention is to provide cleaning method of a cleaning robot, and the cleaning method includes when the cleaning robot continuously travels along an obstacle, driving a rear end of the cleaning robot on which a cleaning member is arranged to make multiple turning motions towards the obstacle and multiple backswings away from the obstacle; controlling a current cleaning zone cleaned in each current turning motion or each backswing to be partially overlapped with or adjacent with a previous cleaning zone cleaned in a previous turning motion or a previous backswing; and when each turning cleaning cycle is completed, controlling the cleaning robot to travel a first distance along the obstacle.

Preferably, the cleaning method further includes when the cleaning robot turns along the obstacle, adjusting the first distance and the numbers of turning motions according to a turning radius of the cleaning robot along the obstacle.

Preferably, when the turning radius of the cleaning robot along the obstacle is small, the first distance traveled by the cleaning robot is large, and the number of turning motions is small. Preferably, when the turning radius of the cleaning robot along the obstacle is small, the first distance traveled by the cleaning robot is small, and the number of turning motions is large.

A fourth aspect of the present invention is to provide a cleaning robot, and the cleaning robot include a processor and a memory, the processor is in communication with the memory, the memory is configured to store instructions, and the processor is configured to implement the above cleaning method by executing the instructions.

A sixth aspect of the present invention is to provide a computer readable storage medium adapted for a cleaning robot, and the computer readable storage medium includes instructions, and the cleaning robot is configured to implement the above cleaning method by executing the instructions.

In comparison with the prior art, during the edge traveling of the cleaning robot along an edge of an obstacle, the rear end of the cleaning robot in the present invention can make a plurality of turning motions and backswings so that the cleaning member can reach to and clean the blind zone, thereby solving the problem of cleaning blind zones when cleaning along obstacles, and improving the cleaning effect of the cleaning robot.

### BRIEF DESCRIPTION OF THE DRAWINGS

The accompanying drawings facilitate an understanding of the various embodiments of this invention. In such drawings:

FIG. 1 is a schematic diagram showing that a conventional cleaning robot linearly travels along an obstacle;

FIG. 2 is a schematic diagram showing that a conventional cleaning robot nonlinearly travels along an obstacle.

FIG. 3 is a schematic diagram showing that a cleaning robot linearly travels along an obstacle according to an embodiment of the present invention;

FIG. 4 is a schematic diagram showing that a cleaning robot linearly travels along an obstacle according to another embodiment of the present invention;

FIG. 5 is a schematic diagram showing that a cleaning robot linearly travels along an obstacle according to one more embodiment of the present invention;

FIG. 6 is a schematic diagram showing that a cleaning robot nonlinearly travels along an obstacle according to an embodiment of the present invention;

FIG. 7 is a schematic diagram showing that a cleaning robot nonlinearly travels along an obstacle according to another embodiment of the present invention;

FIG. 8 is a flowchart of a cleaning method according to an embodiment of the present invention.

FIG. 9 is a flowchart of a cleaning method according to another embodiment of the present invention; and

FIG. 10 is a schematic block diagram of a cleaning robot according to an embodiment of the present invention.

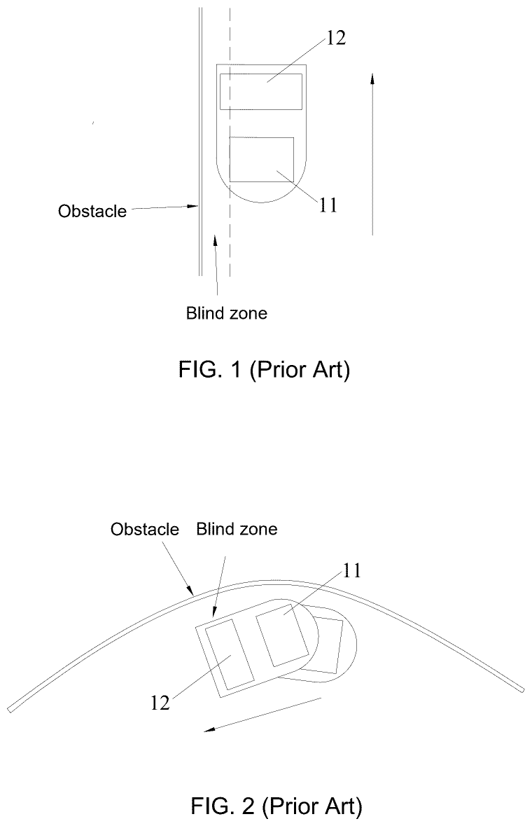

### DETAILED DESCRIPTION OF ILLUSTRATED EMBODIMENTS

In order to explain in detail the technical content, construction features, the purpose and effect achieved by the present invention, the following combined with the implementation and the attached drawings are described in detail. Obviously, the described embodiments are only a part of the embodiments of the present invention, rather than all the embodiments. The following description of at least one exemplary embodiment is actually only illustrative, and in no way shall it be construed as limitation to the present invention or its application or use. Based on the embodiments of the present invention, all other embodiments obtained by a person ordinarily skilled in the art without carrying out creative work shall fall within the protection scope of the present invention.

### Embodiment One

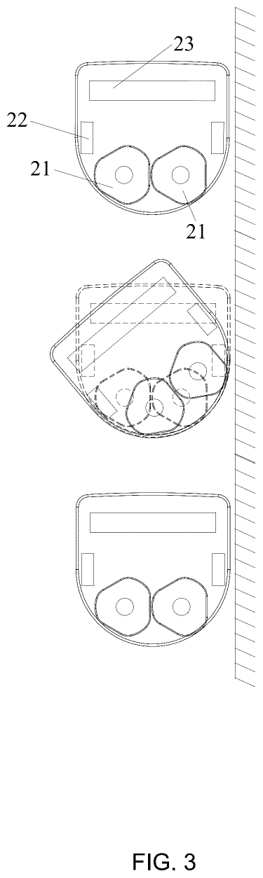

FIGS. 3-7 respectively show a schematic diagram when a cleaning robot linearly or nonlinearly travels along an obstacle. In travelling process of the cleaning robot, a cleaning method according to the present invention can be applied.

Referring to FIGS. 3-7, the present invention discloses a cleaning method of a cleaning robot, and the cleaning robot includes a cleaning member 21 arranged at a rear end of the cleaning robot. The cleaning method includes: when the cleaning robot travels along an obstacle, driving the rear end of the cleaning robot to make multiple turning motions towards the obstacle (as shown in FIGS. 3-5) and multiple backswings away from the obstacle, thereby cleaning a blind zone of the cleaning robot relative to the obstacle. In the present disclosure, an end of the cleaning robot following behind the travelling of the cleaning robot is defined as a rear end of the cleaning robot.

The cleaning robot of the present invention can make multiple turning motions of the rear end of the cleaning robot so as to reach to and clean a blind zone of the cleaning robot relative to the obstacle. As a result, the cleaning effect of the cleaning robot is significantly improved.

In the present disclosure, a blind zone means a gap or an area formed between the cleaning member 21 and the obstacle and cannot be cleaned by the cleaning member 21 in an initial travelling direction of cleaning robot.

Specifically, the turning motions and the backswings of the rear end of the cleaning robot are implemented by controlling a driving device of the cleaning robot. For example, in some embodiments, two driving wheels 22 (as shown in FIGS. 3 to 5) are provided at the bottom rear end of the cleaning robot, and the rear end of the cleaning robot can be turned or swing back by controlling the two driving wheels 22.

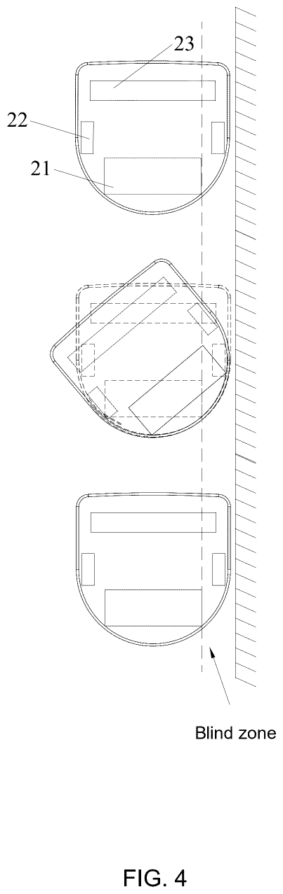

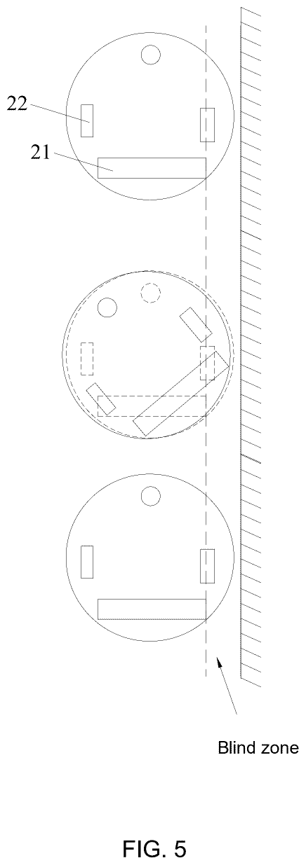

The “cleaning member” in the present disclosure can be in various forms, as long as it can serve as a cleaner. For example, it can be a mop, a wiper, a roller brush, etc., which is not limited here. Optionally, the cleaning member 21 may be stationary relatively cleaning robot, or may rotate or move relative to a chassis of the cleaning robot, which is not limited. In the examples shown in FIGS. 3, 6 and 7, the cleaning member 21 is a wiper that can rotate relative to the chassis of the cleaning robot. In the examples shown in FIGS. 4 and 5, the cleaning member is a mop attached to the chassis of the cleaning robot.

In addition to the “cleaning member”, other modules of the cleaning robot in the present invention may also be in various forms. For example, in addition to the above-mentioned cleaning members, the cleaning robot may or may not be provided with other cleaning members, as shown FIG. 3 for example, a sweeper 23 is arranged at the front end of the cleaning robot. Optionally, the cleaning robot may have various overall shapes, as illustrated in FIG. 3 and FIG. 5 respectively showing different overall shapes but having the same function. It should be noted that any cleaning robot using the present cleaning method to clean a blind zone is covered by the protection scope of the present invention.

In the present disclosure, “turning motion” refers to a motion made by a rear end of the cleaning robot with a preset turning angle relative to the initial travelling direction of the cleaning robot along an obstacle, so that a cleaning member 21 configured at the rear end of the cleaning robot can reach to and clean the blind zone that cannot be cleaned in the initial travelling direction of cleaning robot. It should be noted that, the “turning motion” in the present invention is not limited to that motion starting from the initial travelling direction of the cleaning robot along the obstacle, as long as the “turning motion” of the cleaning robot can result a cleaning to the blind zone. For example, when the cleaning robot starts a turning motion, the rear end of the cleaning robot can be turned to that side away from the obstacle relative to the initial travelling direction.

In the present disclosure, “travelling direction along the obstacle” refers to a normal travelling direction of the cleaning robot along an obstacle in a conventional manner, with a proper gap between the cleaning robot and the obstacle. During the cleaning process of the cleaning robot travelling along the obstacle, the gap or area formed between the cleaning member 21 and the obstacle forms a clean blind zone.

“Swinging back” or “backswings” in the present disclosure means that the rear end of the cleaning robot returns back from a previous turning position (a position at the end of a turning motion). It should be noted that the degree of backswing is not strictly limited, the rear end of the cleaning robot can swing back to an initial travelling direction of the cleaning robot, or to another travelling direction that is deviated from the initial travelling direction.

In some embodiments, the cleaning method further includes controlling a current cleaning zone cleaned in each current turning motion of the cleaning member 21 to be partially overlapped with or adjacent with a previous cleaning zone cleaned in a previous turning motion.

Note that, “a current cleaning zone cleaned in each current turning motion” means a corresponding zone of blind zone that is reached and covered by the cleaning member 21 due to the current turning motion.

Optionally, “adjacent” means that the both are abutted with one another, or spaced apart one another.

In some embodiments, the cleaning method further includes driving the rear end of the cleaning robot to make the turning motions towards the obstacle if a constraint condition of travelling along the obstacle is satisfied, so as to ensure the cleaning effect of the blind zone by the cleaning member 21.

Said “constraint condition of traveling along the obstacle” in the present invention is set for the cleaning robot to smoothly clean in the normal travelling direction along the obstacle so as to prevent the cleaning robot from deviating from the normal travelling direction. Once the cleaning robot does not meet that constraint condition, the position of the cleaning robot can be adjusted by turning or steering, etc., so that the cleaning robot can return to the normal travelling direction. Of course, one or more constraint conditions may be set. When more than one constraint condition is set, at least one of the constraint conditions must be met to proceed with a turning motion. In addition, other constraint conditions may be further set to proceed with such a turning motion.

As a preferable embodiment, the constraint condition of travelling along the obstacle includes that a distance between the cleaning robot and the obstacle satisfies a preset distance condition. That is to say, the rear end of the cleaning robot will make a turning motion towards the obstacle once said distance is desired, to ensure the cleaning effect to the blind zone. Of course, other constraint conditions may be set to trigger that turning motion.

Specifically, during the normal travelling of the cleaning robot, the distance between the cleaning robot and the obstacle may be detected in real time to determine the preset distance condition is met or not. If the preset distance condition is not satisfied, the position of the cleaning robot will be adjusted by turning or steering, etc., so as to return to the normal travelling direction to ensure a stable travel along the obstacle. For example, when linearly travelling along the obstacle (travelling along a straight edge or wall), the linear travelling may be ensured by setting a present distance condition. Such a preset distance condition is also a preset distance condition that needs to be met for each turning motion of the rear end of the cleaning robot in the present invention.

In a preferred example, the preset distance condition is that the distance between the cleaning robot and the obstacle detected in real time is equal to a preset distance threshold. In such a configuration, the cleaning effect of the blind zone is ensured.

Of course, the preset distance condition is not limited to the above preferred example. For example, the preset distance condition may also be that the distance between the cleaning robot and the obstacle detected in real time falls within a preset distance interval having a relative small range.

In the present disclosure, the meaning of “the distance between the cleaning robot and the obstacle” is not limited specifically, it can refer to a distance between a fiducial point and a corresponding position of the obstacle, or a distance between two or more position points of the cleaning robot and a corresponding position of the obstacle, for example.

The acquisition method of the distance between the cleaning robot and the obstacle may be different for different cleaning robots. For example, Chinese patent applications CN201910008516.3 and CN201910008517.8 disclose specific examples of how to obtain said distance.

In some embodiment, the cleaning method further includes driving the rear end of the cleaning robot to make the turning motions towards the obstacle in a preset turning angle, which is conducive to the cleaning robot to perform a stable cleaning, thereby facilitating the cleaning effect on the blind zone of the cleaning member 21.

In some embodiments, the cleaning method further includes driving the rear end of the cleaning robot to make the turning motions towards the obstacle when the cleaning robot stops travelling. In other words, when a condition required for turning is met, the cleaning robot will stop the original travelling, and then the rear end of the cleaning robot will turn toward the obstacle with a preset turning angle. In such a way, larger blind zone will be reached to improve the cleaning effect.

Preferably, a current cleaning zone cleaned by the cleaning member 21 in each current turning motion is partially overlapped with or adjacent with a previous cleaning zone in a previous backswing. In the present disclosure, the “cleaning zone cleaned in the turning motion” refers to the area covered by the cleaning member 21 when the turning motion is done; while the “cleaning zone cleaned in the backswing” refers to the area covered by the cleaning member 21 when the backswing is done. Specifically, the rear end of the cleaning robot swings back from a previous turning position (the position while the turning motion is done) in a state where the normal traveling of the cleaning robot is stopped. Since the turning motions and the backswings are triggered at the same position, therefore it is further conducive to reliable cleaning.

After the rear end of the cleaning robot returns back, the cleaning robot will continue to travel and perform a next turning motion and a next backswing at a next pause location until the preset cleaning procedure is finished.

In this embodiment, although the turning motion of the rear end of the cleaning robot is made when the normal travelling is stopped, the backswings of the rear end of the cleaning robot may not be limited like that. For example, the backswings may also be made during the normal travelling process of the cleaning robot, that is, swinging back while travelling. Under this circumstance, the current movement of the cleaning robot includes a normal travelling movement and a backswing movement.

In addition, in other embodiments, the turning motion of the rear end of the cleaning robot may also be made during the normal travelling process of the cleaning robot, that is, turning while travelling. Under this circumstance, the current movement of the cleaning robot includes a normal travelling movement and a turning movement. In this case, the way of swinging back of the rear end of the cleaning robot is not limited either.

In some embodiments, preferably, the cleaning method of the present invention further includes driving the rear end of the cleaning robot to start the turning motions towards the obstacle, along an initial travelling direction of the cleaning robot along the obstacle; and driving the rear end of the cleaning robot to make the backswings to the initial travelling direction or a previous position. In such a way, the cleaning robot can rapidly respond a turning motion, a backswing or a travelling movement, which is beneficial to shorten the overall cleaning time along the obstacle.

In some embodiments, preferably, the turning motions and the backswings are made during continuous travelling of the cleaning robot. Therefore, the cleaning effect to the blind zone is improved, and the overall cleaning efficiency is improved accordingly.

Optionally, the cleaning robot travels in a wave style or a zigzag style.

### Embodiment Two

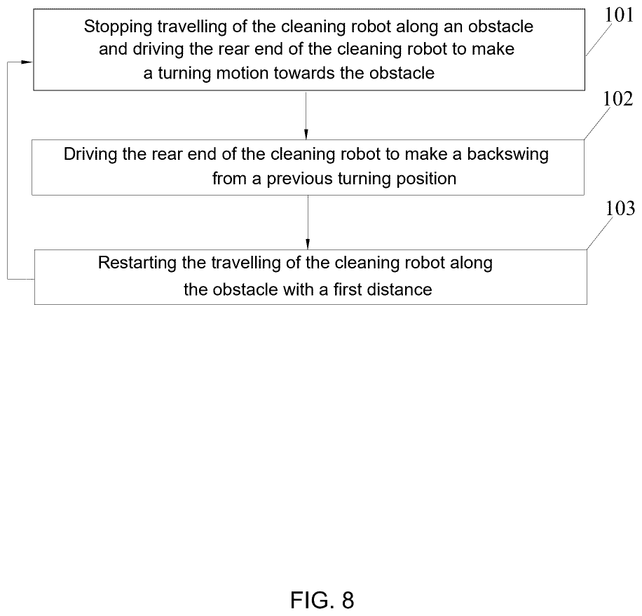

Referring to FIGS. 3 to 8, the present invention discloses a cleaning method of a cleaning robot, and the cleaning robot includes a cleaning member 21 arranged at a rear end of the cleaning robot. The cleaning method includes the following steps:

101, stopping travelling of the cleaning robot along an obstacle and driving the rear end of the cleaning robot to make a turning motion towards the obstacle. When the turning motion of the rear end of the cleaning robot is completed, that is, when the cleaning robot is in a turning position, the cleaning member 21 will be turned to a blind zone formed between the original position of the cleaning member 21 and the obstacle, so as to clean the blind zone. Since the turning motion of the rear end of the cleaning robot toward the obstacle is performed in a travel-stopped state, it is beneficial to improve the cleaning effect of the cleaning member 21 on the blind zone.

102, driving the rear end of the cleaning robot to make a backswing from a previous turning position. That is to say, when the cleaning robot swings back from the previous turning position, it is still performed in a travel-stopped state. In the absence of interference, the cleaning robot will normally return to the position at the beginning of the turning. Since the position at the beginning of the turning and the position at the end of the swinging back are the same, it is beneficial to improve the cleaning effect of the cleaning member 21 on the blind zone and improve the cleaning efficiency finally.

103, restarting the travelling of the cleaning robot along the obstacle with a first distance.

In some embodiments, the first distance is less than or equal to the cleaning width of the cleaning member 21 in the travelling direction along the obstacle. Depending on the cleaning member 21, the cleaning width may be different. For example in FIG. 3, the cleaning width may be the range covered by the cleaning member 21 rotating along the travelling direction; in FIG. 4, the cleaning width may be the width of the cleaning member 21 itself; and when the cleaning member is a roller brush, the cleaning width may be the diameter of the roller brush.

Optionally, the travelling direction along the obstacle may be parallel to an outer contour of the obstacle, or non-parallel to the outer contour of the obstacle.

Then, the cleaning robot repeat the above steps 101-103 until the cleaning operation along the obstacle in the current stage is completed or the current cleaning strategy is changed.

In conclusion, the rear end of the cleaning robot in the present invention can make a plurality of turning motions so that the cleaning member 21 can reach to and clean the blind zone, thereby solving the problem of cleaning blind zones when cleaning along obstacles, and improving the cleaning effect of the cleaning robot.

In some embodiments, the cleaning method of the present invention further includes controlling a current cleaning zone in each current turning motion to be partially overlapped with or adjacent with a previous cleaning zone in a previous turning motion, thereby facilitating the cleaning of the blind zone.

In the present disclosure, the cleaning zone that is covered by each turning motion of the cleaning member 21 is adjacent to the previous cleaning zone covered in the previous turning motion, that is, the both zones are closely next to each other. Of course, the both zones may also be spaced apart.

### Embodiment Three

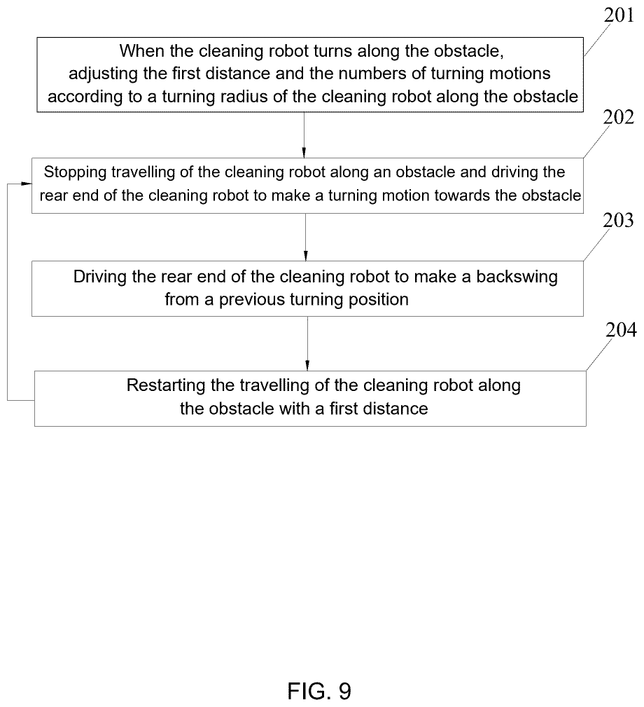

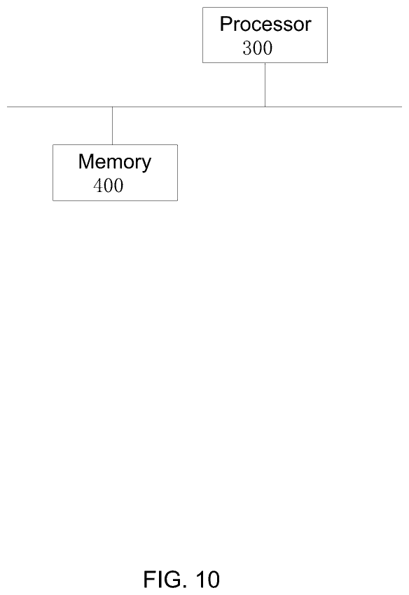

Referring to FIGS. 3-7 and FIG. 9, the present invention discloses a cleaning method of a cleaning robot, and the cleaning robot includes a cleaning member 21 arranged at a rear end of the cleaning robot. The cleaning method includes the following steps:

201, when the cleaning robot turns along the obstacle (travels along a curved edge or wall), adjusting the first distance and the numbers of turning motions according to a turning radius of the cleaning robot along the obstacle. In this embodiment, the cleaning robot may set different turning radius to realize the turning along a curved edge or a curved wall of the obstacle.

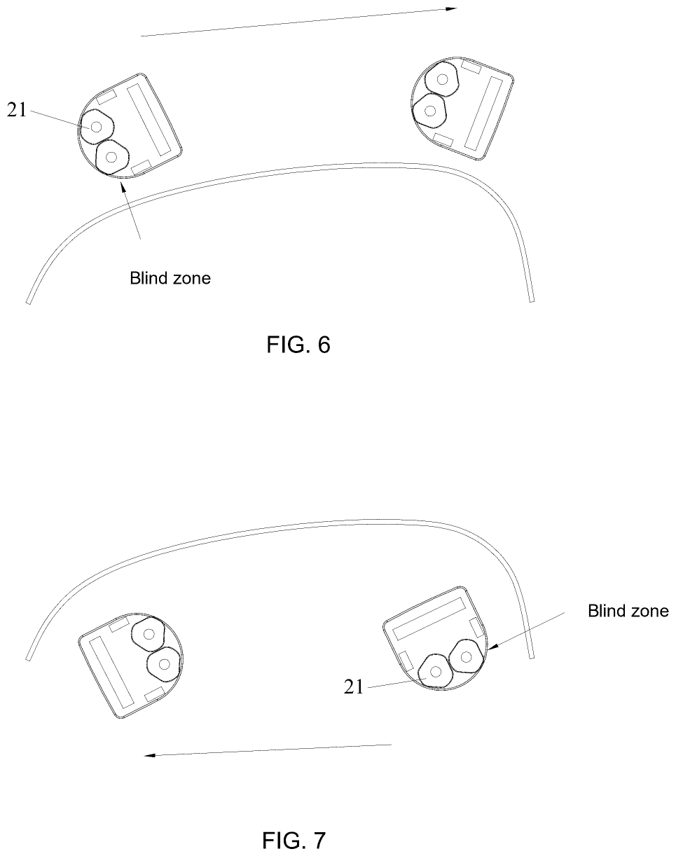

FIG. 6 shows an example that the cleaning robot travels along an outer side of the obstacle (travels around the obstacle). If the turning radius of the cleaning robot when turning along the obstacle is smaller, the overlapping area between the current cleaning zone in each current turning motion and a previous cleaning zone in a previous backswing will be larger, and the distance of the cleaning robot travels each time will be larger, accordingly, the times of turning motions and backswings will be reduced.

FIG. 7 shows an example that the cleaning robot travels along an inner side of the obstacle. If the turning radius of the cleaning robot when turning along the obstacle is smaller, the overlapping area between the current cleaning zone in each current turning motion and a previous cleaning zone in a previous backswing will be smaller, and the distance of the cleaning robot travels each time will be smaller, accordingly, the times of turning motions and backswings will be increased.

202, stopping travelling of the cleaning robot along an obstacle and driving the rear end of the cleaning robot to make a turning motion towards the obstacle.

203, driving the rear end of the cleaning robot to make a backswing from a previous turning position.

204, restarting the travelling of the cleaning robot along the obstacle with a first distance.

Then, the cleaning robot repeat the above steps 202-204 until the cleaning operation along the obstacle in the current stage is completed (preset turning motions are completed) or the current cleaning strategy is changed.

Optionally, the travelling direction along the obstacle may be parallel to an outer contour of the obstacle, or non-parallel to the outer contour of the obstacle.

In conclusion, the rear end of the cleaning robot in the present invention can make a plurality of turning motions so that the cleaning member 21 can reach to and clean the blind zone, thereby solving the problem of cleaning blind zones when cleaning along obstacles, and improving the cleaning effect of the cleaning robot.

### Embodiment Four

The present invention discloses a cleaning method of a cleaning robot, and the cleaning robot includes a cleaning member 21 arranged at a rear end of the cleaning robot. The cleaning method includes the following steps:
during a continuous travel of the cleaning robot along an obstacle, driving a rear end of the cleaning robot on which a cleaning member is arranged to make multiple turning motions towards the obstacle and multiple backswings away from the obstacle;
controlling a current cleaning zone in each current turning motion or each backswing to be partially overlapped with or adjacent with a previous cleaning zone in a previous turning motion or a previous backswing; and
when each turning cleaning cycle is completed, controlling the cleaning robot to travel a second distance along the obstacle.

In some embodiments, the cleaning method further includes when the cleaning robot turns along the obstacle, adjusting the second distance and the numbers of turning motions according to a turning radius of the cleaning robot along the obstacle.

In some embodiments, the second distance is less than or equal to twice the cleaning width of the cleaning member 21 in the traveling direction of the obstacle. Specifically, the second distance is a displacement of the cleaning robot in the travelling direction when the cleaning robot completes a cycle of turning and backswing during the continuous travel.

Depending on the cleaning member 21, the cleaning width may be different. For example in FIG. 3, the cleaning width may be the range covered by the cleaning member 21 rotating along the travelling direction; in FIG. 4, the cleaning width may be the width of the cleaning member 21 itself; and when the cleaning member is a roller brush, the cleaning width may be the diameter of the roller brush.

In some embodiments for example the cleaning robot travels along an outer side of the obstacle (travels around the obstacle), if the turning radius of the cleaning robot when turning along the obstacle is smaller, the overlapping area between the current cleaning zone in each current turning motion and a previous cleaning zone in a previous backswing will be larger, and the distance of the cleaning robot travels each time will be larger, accordingly, the times of turning motions and backswings will be reduced.

In some embodiments for example the cleaning robot travels along an inner side of the obstacle, if the turning radius of the cleaning robot when turning along the obstacle is smaller, the overlapping area between the current cleaning zone in each current turning motion and a previous cleaning zone in a previous backswing will be smaller, and the distance of the cleaning robot travels each time will be smaller, accordingly, the times of turning motions and backswings will be increased.

Of course, the cleaning methods of the present invention in the above embodiments are only examples and should not be used to limit the present invention. All in all, when cleaning along the obstacle, any solution that drives the rear end of the cleaning robot to make turning motions and backswings toward the obstacle thereby cleaning the blind area shall fall within the protection scope of the present invention.

### Embodiment Five

A cleaning robot of the present embodiment includes a processor 300 and a memory 400, and the processor 300 is in communication with the memory 100, the memory 400 is configured to store instructions, and the processor 300 is configured to implement the above cleaning method by executing the instructions.

### Embodiment Six

A computer readable storage medium of the present embodiment is adapted for a cleaning robot and is configured to store instructions, and the cleaning robot is configured to implement the above cleaning method by executing the instructions.

It should be noted that each embodiment of the present invention focuses on the differences from other embodiments, and the same or similar parts between the various embodiments can be referred to each other.

While the invention has been described in connection with what are presently considered to be the most practical and preferred embodiments, it is to be understood that the invention is not to be limited to the disclosed embodiments, but on the contrary, is intended to cover various modifications and equivalent arrangement included within the spirit and scope of the invention.

What is claimed is:

1. A method of cleaning a surface using a cleaning robot, the cleaning robot including a body and a cleaning member arranged on a rear end of the body, the cleaning member having at least one mopping member, the method including:
(a) controlling the cleaning robot to travel linearly along an obstacle for a first distance, wherein a minimum distance between the cleaning member and an edge of the obstacle is greater than a minimum distance between the body of the cleaning robot and the edge of the obstacle when the cleaning robot travels linearly along the obstacle, wherein the cleaning robot has a blind zone on the surface formed between the cleaning member and the obstacle when the cleaning robot travels linearly along the obstacle, and wherein the blind zone includes an area that cannot be cleaned by at least a part of the cleaning member when the cleaning robot travels linearly along the obstacle;
(b) causing the cleaning robot to stop traveling;
(c) driving the rear end of the cleaning robot to make a turning motion towards the obstacle;
(d) driving the rear end of the cleaning robot to make a backswing away from the obstacle; and
(e) performing a plurality of iterations of (a)-(d) and cleaning at least a portion of the blind zone on the surface using the cleaning member while performing the iterations of (a)-(d).

2. The method of claim 1, wherein the body has a greater dimension than the cleaning member in a lateral direction of the cleaning robot, and the lateral direction is perpendicular to a traveling direction of the cleaning robot.

3. The method of claim 1, further comprising forming a first cleaning zone using the cleaning member in each iteration of (c) and (d), wherein the first cleaning zone formed in a current iteration at least partially overlaps or touches the first cleaning zone formed in a previous iteration.

4. The method of claim 3, further comprising driving the rear end of the cleaning robot to make the turning motion towards the obstacle based on a constraint condition of traveling along the obstacle being satisfied.

5. The method of claim 4, wherein the constraint condition of traveling along the obstacle comprises:
a detected distance between the cleaning robot and the obstacle being smaller than or equal to a preset distance threshold.

6. The method of claim 4, wherein the first distance is smaller than or equal to a dimension of the first cleaning zone along a traveling direction of the cleaning robot.

7. The method of claim 3, further comprising forming a second cleaning zone when the cleaning robot travels linearly along the obstacle, wherein the first cleaning zone and the second cleaning zone at least partially overlap or touch each other.

8. The method of claim 1, further comprising at least one of:
causing the rear end of the cleaning robot to start turning towards the obstacle; and
driving the rear end of the cleaning robot to make the backswing back to a direction of travelling along the obstacle or an initial position before the turning motion.

9. The method of claim 1, wherein driving the cleaning robot to move in a wave style or a zigzag style.

10. The method of claim 1, further comprising, when the cleaning robot turns along the obstacle having a curve shape, adjusting the first distance and a number of iterations of (a)-(d) according to a turning radius of the cleaning robot.

11. The method of claim 10, further comprising when the turning radius of the cleaning robot is reduced, increasing the first distance traveled by the cleaning robot, and reducing the number of iterations of (a)-(d).

12. The method of claim 10, further comprising when the turning radius of the cleaning robot is reduced, reducing the first distance traveled by the cleaning robot, and increasing the number of iterations of (a)-(d).

13. The method of claim 1, further comprising driving the rear end of the cleaning robot to turn a preset angle.

14. A cleaning robot for cleaning a surface, comprising:
a body;
a cleaning member arranged on a rear end of the body, the cleaning member having at last one mop, wherein a minimum distance between the cleaning member and the obstacle is greater than a minimum distance between the body of the cleaning robot and an obstacle when the cleaning robot travels linearly along the obstacle, wherein the cleaning robot has a blind zone on the surface formed between the cleaning member and the obstacle when the cleaning robot travels linearly along the obstacle, and wherein the blind zone includes an area that cannot be cleaned by at least a part of the cleaning member when the cleaning robot travels linearly along the obstacle;
a processor; and
a memory coupled to the processor, the memory being configured to store computer-readable instructions, and the processor being configured to execute the computer-readable instructions to facilitate:
(a) controlling the cleaning robot to travel linearly along the obstacle for a first distance;
(b) causing the cleaning robot to stop traveling;
(c) driving the rear end of the cleaning robot to make a turning motion towards the obstacle;
(d) driving the rear end of the cleaning robot to make a backswing away from the obstacle; and
(e) performing a plurality of iterations of (a)-(d) and cleaning at least a portion of the blind zone on the surface using the cleaning member while performing the iterations of (a)-(d).

15. The cleaning robot of claim 14, wherein the body has a greater dimension than the cleaning member in a lateral direction of the cleaning robot, and the lateral direction is perpendicular to a traveling direction of the cleaning robot.

16. The cleaning robot of claim 14, the processor being configured to execute the computer-readable instructions to further facilitate forming a first cleaning zone using the cleaning member in each iteration of (c) and (d), wherein the first cleaning zone formed in a current iteration partially overlaps the first cleaning zone formed in a previous iteration.

17. The cleaning robot of claim 16, the processor being configured to execute the computer-readable instructions to further facilitate driving the rear end of the cleaning robot to make the turning motion towards the obstacle based on a constraint condition of traveling along the obstacle being satisfied.

18. The cleaning robot of claim 17, wherein the constraint condition of traveling along the obstacle comprises:
a detected distance between the cleaning robot and the obstacle being smaller than or equal to a preset distance threshold.

19. The cleaning robot of claim 17, wherein the first distance is smaller than or equal to a dimension of the first cleaning zone along the obstacle.

20. A non-transitory computer readable storage medium, having computer-executable instructions stored thereon, the computer-executable instructions, when executed by one or more processors, causing the one or more processors to facilitate:
(a) controlling a cleaning robot to travel linearly along an obstacle for a first distance, wherein the cleaning robot includes a body and a cleaning member arranged on a rear end of the body, the cleaning member having at least one mop, wherein a minimum distance between the cleaning member and the obstacle is greater than a minimum distance between the body of the cleaning robot and the obstacle when the cleaning robot travels linearly along the obstacle, wherein the cleaning robot has a blind zone on the surface formed between the cleaning member and the obstacle when the cleaning robot travels linearly along the obstacle, and wherein the blind zone includes an area that cannot be cleaned by at least a part of the cleaning member when the cleaning robot travels linearly along the obstacle;
(b) causing the cleaning robot to stop traveling;
(c) driving the rear end of the cleaning robot to make a turning motion towards the obstacle;
(d) driving the rear end of the cleaning robot to make a backswing away from the obstacle; and
(e) performing a plurality of iterations of (a)-(d) and cleaning at least a portion of the blind zone on the surface using the cleaning member while performing the iterations of (a)-(d).
